(19) United States
(12) Patent Application Publication
(10) Pub. No.: US 2013/0166318 A1
(43) Pub. Date: Jun. 27, 2013

(54) SYSTEM AND TECHNIQUES FOR COST ESTIMATION OF MEDICAL CONDITIONS ACQUIRED AT A MEDICAL FACILITY

(71) Applicants: Catherine D. Lathem, Komoka (CA); Keith C. Mitchell, Atlanta, GA (US); Cathy L. Plunkett, Kennesaw, GA (US); Cheryl A. Pederson, Eden Prairie, MN (US); Mary E. Kundus, Hudson, WI (US); Mark A. Schroer, Burnsville, MN (US); Barbara C. Zellerino, Newburgh, IN (US); Garri L. Garrison, Atlanta, GA (US); Monica L. Sanders, Portland, ME (US); JaeLynn C. Williams, Sandy, UT (US)

(72) Inventors: Catherine D. Lathem, Komoka (CA); Keith C. Mitchell, Atlanta, GA (US); Cathy L. Plunkett, Kennesaw, GA (US); Cheryl A. Pederson, Eden Prairie, MN (US); Mary E. Kundus, Hudson, WI (US); Mark A. Schroer, Burnsville, MN (US); Barbara C. Zellerino, Newburgh, IN (US); Garri L. Garrison, Atlanta, GA (US); Monica L. Sanders, Portland, ME (US); JaeLynn C. Williams, Sandy, UT (US)

(73) Assignee: 3M INNOVATIVE PROPERTIES COMPANY, ST. PAUL, MN (US)

(21) Appl. No.: 13/820,036

(22) PCT Filed: Sep. 15, 2011
(86) PCT No.: PCT/US11/51766

§ 371 Date: Feb. 28, 2013

Related U.S. Application Data
(60) Provisional application No. 61/383,044, filed on Sep. 15, 2010.

(51) Int. Cl. G06F 19/00; G06Q 50/22

(52) U.S. Cl. CPC G06F 19/328; G06Q 50/22
USPC 705/2

(57) ABSTRACT

Computer-implemented methods of processing medical data are described. The methods comprise selecting cases associated with a first parameter from medical data associated with a plurality of cases, determining a subset of cases associated with a medical facility-acquired condition, and determining another subset cases not associated with the medical facility-acquired condition. Estimated costs associated with those cases associated a medical facility-acquired condition are generated, along with expected costs for these same cases in the absence of the medical facility-acquired condition. Methods further allowing comparisons to data related to normative collections of medical facilities are also disclosed. Computerized systems for processing medical data and computer-readable storage media comprising instructions that when executed in a processor cause the processor to process medical data are also described.

### TECHNICAL FIELD

This disclosure relates to health care at medical facilities, and cost estimations associated with medical conditions.

### BACKGROUND

In the heathcare field, it is often desirable to determine costs associated with medical conditions. Most medical facilities operate, in many respects, like other businesses, in that profits or losses generally amount to the difference between charges imposed by the medical facility for a given service and the costs associated with providing that service. Furthermore, like other businesses, medical facilities do not always gain full reimbursement for the charges, which can reduce profits.

The healthcare field is changing rapidly. One recent change in healthcare relates to the reimbursement of medical procedures by the Medicare program sponsored by the United States. In particular, Medicare recently changed its policy on reimbursement for medical conditions that were acquired at the medical facility. For example, if a patient is admitted to a medical facility for treatment of a first condition (e.g., a knee surgery), but is then exposed to a second condition (e.g., a surgical site infection) at that medical facility, Medicare may refuse payment for treatment of that second condition on the rationale that the second condition was attributable to the medical facility. Health insurance companies or other government agencies responsible for reimbursement of healthcare costs may follow Medicare's policy of refusing payment for treatment of the second condition in such circumstances.

### SUMMARY

This disclosure describes systems and techniques for calculating and reporting costs associated with medical conditions. In particular, the techniques of this disclosure may provide the ability to ascertain specific costs associated with medical conditions acquired by a patient at a medical facility, which may be disallowed from reimbursement by a reimbursement entity, such as a private insurance company or a government agency. One example of a reimbursement entity is the Medicare program run by the United States Government. Other countries may have similar government-run reimbursement systems. As used herein, “reimbursement” includes both a refund by the reimbursement entity for costs incurred by a patient receiving treatment at a medical facility as well as direct payment by a reimbursement entity to the medical facility on behalf of a patient receiving treatment at a medical facility.

The disclosed system and techniques may perform data mining a set of medical data in order to ascertain useful information. In this way, a medical facility can become better informed of its non-reimbursed costs, and may take active steps to remedy specific areas of medical treatment where such non-reimbursed costs are significant.

In one embodiment, this disclosure describes a computer-implemented method of processing medical data. The method comprising selecting a first subset of cases associated with a first parameter from medical data associated with a plurality of cases; determining a second subset of the first subset of cases associated with at least one medical facility-acquired condition; and determining a third subset of the first subset of cases not associated with the at least one medical facility-acquired condition. The method also comprises generating estimated costs associated with the second subset of cases and generating expected costs of the second subset of the first subset of cases in the absence of the at least one medical facility-acquired condition. Generating the estimated costs comprises determining actual charges for the second subset of cases, identifying a cost metric, and calculating the estimated costs associated with the second subset of cases based on the actual charges for the second subset of cases and the cost metric. Generating the expected costs comprises determining actual charges for the third subset of cases, and calculating the expected costs based on the actual charges for the third subset of cases and the cost metric.

In another embodiment the present disclosure provides a computerized system for processing medical data. The system comprising a computer that includes a first module that selects a first subset of cases associated with a first parameter from medical data associated with a plurality of cases; a third module that determines a second subset of the first subset of cases associated with at least one medical facility-acquired condition; and a third module that determines a third subset of the first subset of cases not associated with the at least one medical facility-acquired condition. The system further includes a fourth module that generates estimated costs associated with the second subset of cases, and a fifth module that generates expected costs of the second subset of the first subset of cases in the absence of the at least one medical facility-acquired condition. Generating the estimated costs comprises determining actual charges for the second subset of cases, identifying a cost metric, and calculating the estimated costs associated with the second subset of cases based on the actual charges for the second subset of cases and the cost metric. Generating the expected costs comprises determining actual charges for the third subset of cases, and calculating the expected costs based on the actual charges for the third subset of cases and the cost metric.

In yet another embodiment, this disclosure provides a computer-readable storage medium comprising instructions that when executed in a processor cause the processor to process medical data. Upon execution the instructions cause the processor to select a first subset of cases associated with the first parameter from medical data associated with a plurality of cases; determine a second subset of the first subset of cases associated with at least one medical facility-acquired condition; determine a third subset of the first subset of cases not associated with the at least one medical facility-acquired condition; generate estimated costs associated with the second subset of cases, and generate expected costs of the second subset of the first subset of cases in the absence of the at least one medical facility-acquired condition. Generating the estimated costs comprises determining actual charges for the second subset of cases, identifying a cost metric, and calculating the estimated costs associated with the second subset of cases based on the actual charges for the second subset of cases and the cost metric. Generating the expected costs comprises determining actual charges for the third subset of cases, and calculating the expected costs based on the actual charges for the third subset of cases and the cost metric.

The techniques of this disclosure may be implemented at least partially in hardware, such as a processor or discrete logic circuits. The techniques may also be implemented using aspects of software or firmware in combination with the hardware. If implemented partially in software or firmware, the software or firmware may be executed in one or more hardware processors, such as a microprocessor, application specific integrated circuit (ASIC), field programmable gate array (FPGA), or digital signal processor (DSP). The software that executes the techniques may be initially stored in a computer-readable storage medium and loaded and executed in the processor. The processor may execute modules to perform the techniques of this disclosure, and the modules may comprise combinations of software and hardware, e.g., software routines executing on the processor.

The details of one or more examples of this disclosure are set forth in the accompanying drawings and the description below. Other features, objects, and advantages associated with the examples will be apparent from the description and drawings, and from the claims.

### BRIEF DESCRIPTION OF DRAWINGS

FIG. 1 is a block diagram illustrating an example of a computerized system for processing medical data consistent with this disclosure.

FIG. 2 is an exemplary computer screen shot that may be used by a user of the computerized system described herein.

FIG. 3 is another exemplary computer screen shot that may be used by a user of the computerized system described herein.

FIG. 4 is a screen shot illustrating specific types of data that may be determined, generated and displayed to a user of the computerized system described herein.

FIGS. 5-9 are exemplary flow diagrams consistent with various techniques described in this disclosure.

FIG. 10 illustrates certain functionality of a computer-implemented method of processing medical data according to some embodiments of the present disclosure.

### DETAILED DESCRIPTION

This disclosure describes systems and techniques for calculating and reporting costs associated with medical conditions. In some examples, the techniques of this disclosure may provide the ability to ascertain specific costs associated with medical conditions acquired by a patient at a medical facility for the different service groups. The different service groups may comprise specific medical conditions or collections of medical conditions within an area of medical practice. In some examples, the costs may be associated with charges that are disallowed from reimbursement by a reimbursement entity, such as a private insurance company or a government agency. The disclosed system and techniques may perform data mining with respect to a set of medical data in order to generate useful information for medical facilities.

In different examples, the medical data may comprise government-acquired medical data from a medical information repository (e.g., Medicare), medical data submitted to a government by the medical facility, medical data submitted to the government by many medical facilities, medical data received from one or more medical facilities, medical data received from one or more insurance companies; and/or medical data associated with all-payer health insurance claims. Many of the techniques are described in the context of government-acquired medical data, although the medical data could come from other sources. In any case, with the techniques of this disclosure, a medical facility can become better informed of selected incremental costs of patient care resources (e.g., non-reimbursed costs) in different service groups, and may take active steps to remedy specific service groups where such costs are significant.

FIG. 10 illustrates certain features of the computer implemented method of processing medical data according to some embodiments of the present disclosure. These features are generic to hardware and/or software used to achieve such computer implemented methods.

Medical data 10 processed by the methods of the present disclosure includes medical data 10a, 10b, . . . 10n associated with a plurality of cases 20, i.e., 20a, 20b, . . . 20n. The medical data may include a wide variety of information associated with each specific case including diagnostic codes, costs, dates, locations, patient demographics, and the like. In some embodiments, the medical data is organized in a data base. Information included in the medical data may be obtained for any one or combination of sources including medical facilities, government agencies, insurance records, and the like.

In processing medical data 10, first subset of cases 31 is selected from plurality of cases 20, where each case in the first subset is associated with a first parameter, e.g., cases 20a through 20d, which are associated with the parameter “A” of medical data 10a. As used herein, a “subset” includes at least one but less than all cases included in the set of cases from which it is drawn. Generally, the first parameter is associated with a specific data field in the medical data. Exemplary first parameters and/or their associated data fields include a geographic region, a medical facility, a service group, and a patient medical procedure, including combinations thereof. In some embodiments, the methods include receiving the first parameter.

Medical data 10 is further processed by determining second subset 32 of first subset of cases 31 (e.g., cases 20a and 20b) and third subset 33 of first subset of cases 31 (e.g., cases 20c and 20d). The cases in second subset 32 are related to each other in that each case is associated with at least one medical facility-acquired condition common to all cases in the second subset, represented by the symbol “X” in column 10n. The cases in third subset of cases are related to each other in that none of the cases are associated with the at least one medical facility-acquired condition, represented by the symbol “O” in column 10n. In some embodiments, the cases within the second and third subset of cases may be related in other aspects, e.g., the most significant difference may be their relationship to the at least one medical-facility acquired condition.

As an example, medical data 10 may contain data on all cases occurring in a particular medical facility. The first parameter may be a particular type of surgery, and, in some embodiments, additional first parameters may be used to further limit the data within the first subset of cases such as a date range. The second subset of cases includes only those cases associated with the first parameter(s) (e.g., the specific type of surgery and date range) illustrated by the symbol “A” in column 10a, that are also associated with at least one medical facility-acquired condition common to all such cases, e.g., a surgical site infection, illustrated by the symbol “X” in column 10n. The third subset of data then includes only cases associated with the first parameter(s) (e.g., the specific type of surgery and date range), i.e., those illustrated by the symbol “A” in column 10a, but not associated with the at least one medical facility-acquired condition, i.e., those that did not have a surgical site infection as illustrated by the symbol “O” in column 10n. Although not required, in some embodiments, the second subset of cases includes all cases within the first subset of cases that are associated with the at least one medical facility-acquired condition. Similarly, in some embodiments, the third subset of cases may include only some or all cases within the first subset of cases that no not have the at least one medical facility-acquired condition.

In addition to indentifying the first, second and third subsets of cases within the medical data, methods of the present disclosure generate estimated costs associated with the second subset of cases, and expected costs for the second subset of cases in the absence of the at least one medical facility-acquired condition. Generating the estimated costs comprises determining actual charges for the second subset of cases and identifying a cost metric. Estimated costs are then calculated based on the actual charges and the cost metric by, e.g., multiplying these two values. The cases in the third subset of cases are used to generate the expected costs of the second subset of the first subset of cases in the absence of the at least one medical facility-acquired condition. The expected costs are generated by determining actual charges for the third subset of cases, and calculating the expected costs based on the actual charges for the third subset of cases and the cost metric.

In some embodiments, the methods also include receiving a second parameter and using the second parameter to determine the one or more medical facility acquired conditions. Exemplary medical facility-acquired conditions may include one or more of an infection acquired at the medical facility; an infection resulting from treatment at the medical facility; an injury that occurred in the medical facility; a complication due to an error at the medical facility; a complication due to an error by personnel providing services on behalf of the medical facility, and a complication due to improper medication at the medical facility. Personnel providing services on behalf of the medical facility include, e.g., those providing services within the medical facility and those providing services remotely from the medical facility, including, e.g., services provided directly such as in-home care, and services provided indirectly such as consultation and telemedicine. Services include direct patient care such as the performance of medical procedures and the administration of medications, as well as procedures such as admittance, cleaning, sterilization, and patient transportation.

In some embodiments, determining the second subset of the first subset of cases comprises identifying cases associated with at least one diagnostic code indicative of the at least one medical facility-acquired condition. For example, referring to FIG. 10, in some embodiments, the second subset of cases 31 may be selected by identifying cases with diagnostic codes “DC1” or “DC2” as shown in column 10b. Generally, the diagnostic codes used to identify cases for inclusion in the second subset cases would be those diagnostic codes indicative of the at least one medical facility-acquired conditions. In some embodiments, cases may be selected based on the presence of a single diagnostic code or the presence of a combination of two or more diagnostic codes. The selection may also be based on the absence of a diagnostic code. In some embodiments, a parameter, e.g., the second parameter, may be used to identify the diagnostic codes.

In some embodiments, the medical data comprises one or more of government-acquired medical data from a medical information repository (e.g., Medicare); medical data submitted to a government by at least one medical facility; medical data received from one or more medical facilities; medical data received from one or more insurance companies; and medical data associated with all-payer health insurance claims. In some embodiments, determining actual charges comprises determining charges submitted to a reimbursement entity. In some embodiments, the cost metric comprises a cost-to-charge metric defined by a ratio in a Medicare Provider Analysis and Review (MEDPAR) repository. In some embodiments, the cost metric is defined by the medical facility.

In some embodiments, the method may include additional steps. For example, in some embodiments, the method includes determining a first number of cases associated with the first parameter from medical data associated with a normative collection of medical facilities; determining a second number of cases within the first number of cases, wherein the second number of cases are associated with the one or more medical facility-acquired conditions; and generating an expected number of cases within the second subset of the first subset of cases based on the first number of cases, the second number of cases, and number of cases within the first subset of cases. In some embodiments, determining the second number of cases comprises identifying cases associated with at least one diagnostic code indicative of the at least one medical facility-acquired condition. In some embodiments, the normative collection of medical facilities are associated with at least one of a same geographic location, a same source of funding, a same source of reimbursement, and a same patient demographic. In some embodiments, the methods comprise receiving a third parameter and using the third parameter to identify the normative collection of medical facilities.

In some embodiments, the methods include generating one or more of: a variance of the second subset of the first subset of cases relative to the expected number of cases within the second subset of cases; a facility-acquired ratio as a ratio of the second subset of cases to the first subset of cases; and a variance of the estimated costs relative to the expected costs.

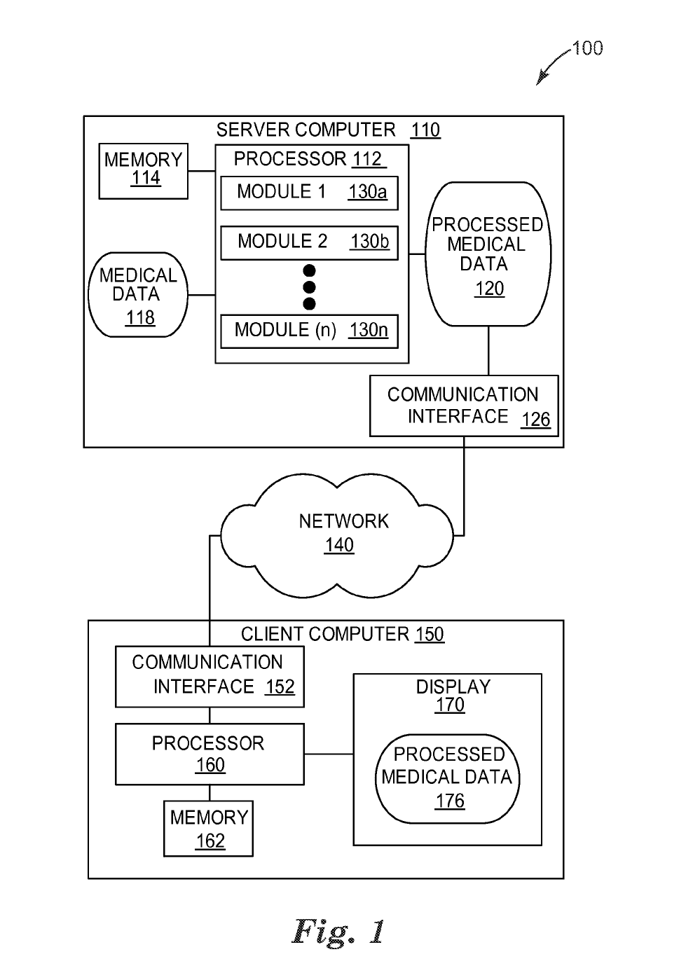

Various features and embodiments are further described with reference to FIGS. 1 to 9.

FIG. 1 is a block diagram of a system 100 in which a server computer 110 processes medical data and communicates the processed medical data to a client computer 150 via a network 140. System 100 is merely exemplary, as the techniques of this disclosure could also be realized on a stand-alone computer.

In the example of FIG. 1, network 140 may comprise a proprietary or non-proprietary network for packet-based communication. In one example, network 140 comprises the Internet, in which case communication interfaces 126 and 152 may comprise interfaces for communicating data according to the transmission control protocol/internet protocol (TCP/IP) standard, or the like. More generally, however, network 140 may comprise any type of communication network, and may support wired communication, wireless communication, fiber optic communication, satellite communication, or any type of techniques for transferring data between a source (e.g., server computer 110) and a destination (e.g., client computer 140).

Server computer 110 may perform data mining with respect to a set of medical data in order to generate useful information for medical facilities. Server computer 110 may then communicate processed medical information to client computer 150 for presentation to a user. The processed medical information may be used to ascertain specific costs associated with medical conditions acquired by a patient at the medical facility and may be grouped according to service groups at the facility. Again, the different service groups may comprise specific medical conditions or collections of medical conditions within an area of medical practice. Also, as noted above, the medical data may comprise government-acquired medical data from a medical information repository (e.g., Medicare), medical data submitted to a government by the medical facility, medical data submitted to the government by many medical facilities, medical data received from one or more medical facilities, medical data received from one or more insurance companies; and/or medical data associated with all-payer health insurance claims.

Some costs associated with medical-facility acquired conditions may be disallowed from reimbursement by a government. The processed medical information may identify such disallowed costs, and may be used to drive cost saving measures or other changes including, e.g., process improvements, in the service groups at a given medical facility. The user at client computer 150 may comprise a medical facility, or possibly a consultant service that may use system 100 to reduce costs or improve services at the medical facility. The user at client computer 150 may also comprise an on-line user or licensee of a service provided by server computer 110.

Server computer 110 may include a processor 112 coupled to memory 114. Processor 112 may comprise a general-purpose microprocessor, a specially designed processor, an application specific integrated circuit, a field programmable gate array, a collection of discrete logic, or any type of processing device capable of processing data as described herein. In one example, memory 114 may store program instructions (e.g., software instructions) that are executed by processor 112 to carry out the techniques described herein.

In general, processor 112 may process medical data 118 in order to generate processed medical data 120. Medical data 118 and processed medical data 120 are shown in FIG. 1 for illustrative purposes, although such data would typically be stored in memory 114 or another storage location (not shown), which may be internal or external to server computer 110. Medical data 118 may be acquired by server computer 110 such as from an external database. As examples, medical data 118 may comprise one or more of government-acquired medical data from a medical information repository, medical data submitted to a government by the medical facility, medical data submitted to the government by many medical facilities, medical data received from one or more medical facilities, medical data received from one or more insurance companies, and medical data associated with all-payer health insurance claims.

Processor 112 may execute modules (130a, 130b, . . . , 130n), which are collectively referred to as modules 130, in order to perform the techniques of this disclosure. Modules 130 may comprise combinations of software and hardware, e.g., software routines executing on processor 112. In other examples, however, modules 130 could be implemented as hardware circuit elements of an application specific integrated circuit (ASIC), discrete logic components, or another type of imbedded processing circuit.

In one specific and non-limiting example, medical data 118 may comprise government-acquired data, such as from the Medicare Provider Analysis and Review (MEDPAR) repository, which is maintained by the United States Medicare program. Medical data 118 may include International Classification of Disease (ICD) codes, such as ICD-9 codes, ICD-10 codes, or other future extensions of the ICD codes. Similar codes may be used and mined if another type of medical data, e.g., non-governmental medical data is used as medical data 118. In the example of data from the MEDPAR repository, processor 112 may perform data mining with respect to the ICD codes and other data available from the MEDPAR repository in order to generate processed medical data 120. Processed medical data 120 may be accessible to a user of client computer 150 via data communication between client computer 150 and server computer 110 over network 140.

As illustrated in FIG. 1, processor 112 includes a plurality of modules 130. Modules 130 are generally illustrated for the purpose of explaining the functions preformed by processor 112. Again, modules 130 may comprise software routines being executed by processor 112, circuit logic elements, or specific circuit elements of an imbedded processor that execute the techniques described herein. In different examples, any number “n” of modules 130 may be supported and executed by processor 112 to perform the techniques described herein. Additional details of the functionality and operation of modules 130 are outlined below. In general, modules 130 represent different functions or operations performed by processor 112 with respect to medical data 118 in order to generate processed medical data 120. In most cases, modules 130 may be integrated as a routine or circuit, but are illustrated and described separately for purposes of explaining the techniques of this disclosure. In different examples, modules 130 may comprise hardware or software executing on hardware, such as on processor 112.

Client computer 150 may comprise a general purpose computer, a laptop computer, desktop computer, notebook computer, palm computer, or possibly a smart phone or other computer associated with an end user. As mentioned, client computer 150 may include a communication interface 152 to support communication with server computer 110 via network 140. As one example, communication interface 152 may support internet-based communication according to the TCP/IP protocol, or the like. However, other wired or wireless communication could also be used. The techniques of this disclosure are not necessarily limited to any type of data communication, and may also be realized via a stand-alone computer without any data communication over network 140. System 100 is merely one exemplary system in which the techniques of this disclosure could be implemented.

Client computer 150 may include a processor 160 coupled to a memory 162 and a display 170, e.g. via a system bus (not shown). In one example, processor 160 may comprise a general-purpose microprocessor that executes Internet browser software cached in memory 162. Such Internet browser software may be initially stored in a non-volatile medium, such as a hard disk (not shown), and may be cached into memory 162 and executed by processor 160. Display 170 may be used to present processed medical data 176 to a user. In general, processed medical data 176 may comprise a selected portion of processed medical data 120 generated at server computer 110. The processed medical data 120 at server computer 110 may be generated, as needed, or could be pre-generated and stored for quick and easy access by client computer 150. The processed medical data 176 presented to the user via display 170 may include data that allows the user to ascertain specific costs associated with medical conditions acquired by a patient at the medical facility for a given service group. Such costs may be disallowed from reimbursement by Medicare, as mentioned above. The data may be organized according to service groups such as orthopedics, surgery, cardiothoracic (CT) surgery, renal, vascular, neurosurgery, woman's health, medicine, cardiology, pulmonary, ophthalmology, transplant, neurology, neonatology, psychiatry, behavioral, and rehabilitation, to name a few. The data could also be organized according to other types of service groups, and in other examples, each of the service groups could be defined as individual conditions, sets of conditions, individual procedures, or sets of procedures. The data may be arranged in web pages served from server computer 110 to client computer 150 via hypertext transfer protocol (HTTP), or the like.

As described in greater detail below, system 100 may allow users to ascertain specific data and statistics for individual medical facilities, such as hospitals, clinics, long-term care facilities, private or public health care facilities or clinics, or the like. In the example where medical data 118 comprises data from the MEDPAR repository any facilities that supply data to the MEDPAR repository may be searchable within system 100 to determine the data and statistics for that facility. The user of system 100 may be a facility administrator, or possibly a consultant that may use system 100 to target and fix problems at one or many medical facilities. A consultant might also use system 100 in order to identify marketing opportunities for medical products or services at selected medical facilities. Also, system 100 could be set up as an on-line service where one or more users of a client computer 150 gain access to system 100 for a license fee.

The techniques of this disclosure may be particularly useful as providing the ability to ascertain specific costs associated with medical facility-acquired conditions specifically acquired by a patient at the medical facility. As mentioned above, such medical facility-acquired conditions may be disallowed from reimbursement by a reimbursement entity, such as a private insurance company or a government agency. By performing data mining with respect to a set of medical data (e.g., medical data 118), server computer 110 may generate useful information (e.g., processed medical data 120) that can help inform facilities of the non-reimbursed costs associated with such medical facility-acquired conditions. Such useful information may aid the facilities in taking active steps to remedy specific medical areas where such non-reimbursed costs are significant.

The phrase “medical facility-acquired conditions” refers to any of a wide variety of conditions that occur while the patient is being cared for at the medical facility. Examples include “health care acquired conditions” as defined by the Center for Disease Control (CDC). For example, medical facility-acquired conditions may include health care associated infections, catheter related blood stream infections (CRBSI), pressure ulcers (which may be common at long term care facilities), surgical site infections (SSI), Staphylococcus aureus or other infections obtained at a medical facility, catheter associated urinary tract infections (UTI), ventilator associated pneumonia (VAP), Clostridium difficile (C-diff) spore bacteria obtained at a medical facility (which are commonly found on surfaces in health care facilities). Many other conditions may also qualify as medical facility-acquired conditions if the conditions are acquired by the patient at the medical facility while the patient is under the care of doctors, nurses, clinicians, or other medical personnel at the medical facility.

In system 100, a user of client computer 150 may be able to select and navigate information via uniform resource locators (URLs) and web links to URLs. The URLs selected or navigated by the user of client computer 150 may identify web pages that present various portions of processed medical data 120. For example, a user of client computer 150 may be able to select a particular type of condition for a particular facility via a web link to a specific URL, and the web page associated with that selected URL may display the number of occurrences of that condition at the facility, percentages of occurrences, or other statistics. A user may also be able to select occurrences for different service groups at the medical facility, which may include conditions themselves or groups of conditions associated with an area of medical practice such as orthopedics, ophthalmology, woman's health, and the like. A user may be able to view top facilities that have the lowest occurrences, worst facilities that have the highest occurrences, or other defined ranges, such as facilities in specific percentage rankings nationally. Each condition may also be searchable by year, month, or other time frame for any given facility.

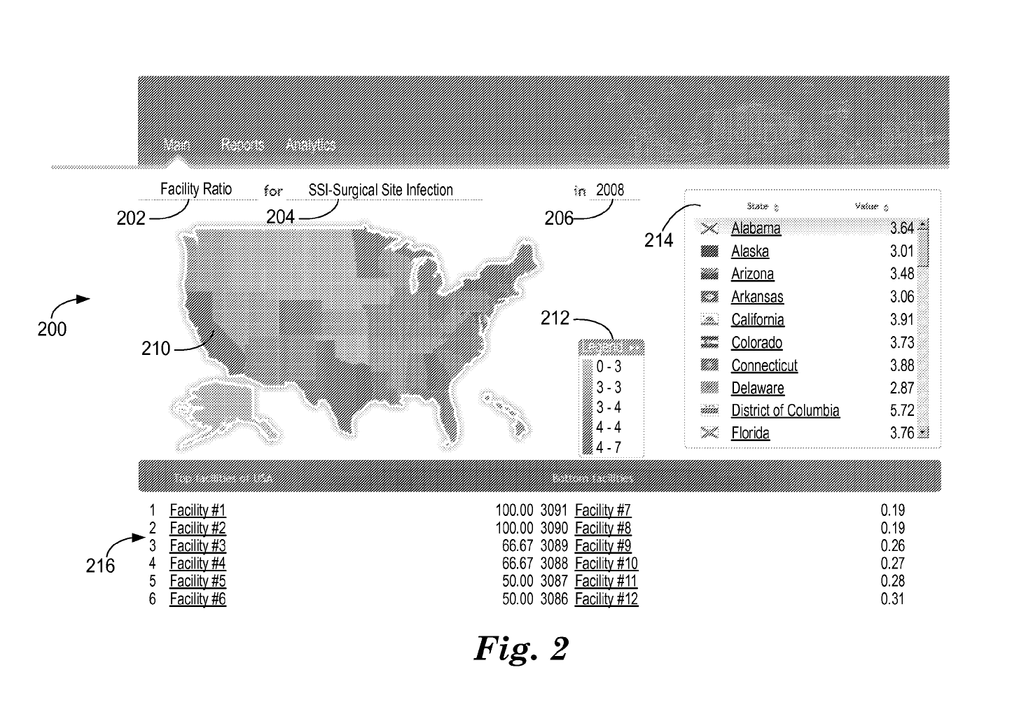

FIG. 2 is an exemplary computer screen shot of a web page 200 that may be delivered from server computer 110 to client computer 150 for presentation to a user of computerized system 100 via display screen 170. Web page 200 may comprise a wide variety of selectable links so as to allow the user to navigate the system via a graphic-user interface. In the example of FIG. 2, the user has selected to view a “facility ratio” 202 for “SSI-Surgical Site Infection” 204 in the year “2008” 206. A map of the United States 210 is illustrated with a legend 212 that shows the average number of occurrences per facility in each state. A window 214 also lists the average number of occurrences per facility in each state, and each state may be selectable from window 214 to provide the user with additional statistics on each individual facility within each state. The top facilities and bottom facilities are also shown in region 216. Web page 200 may be navigable via selectable links so that a user can find information on any given medical facility within any state. Various other tools may also be supported, such as the ability to generate reports.

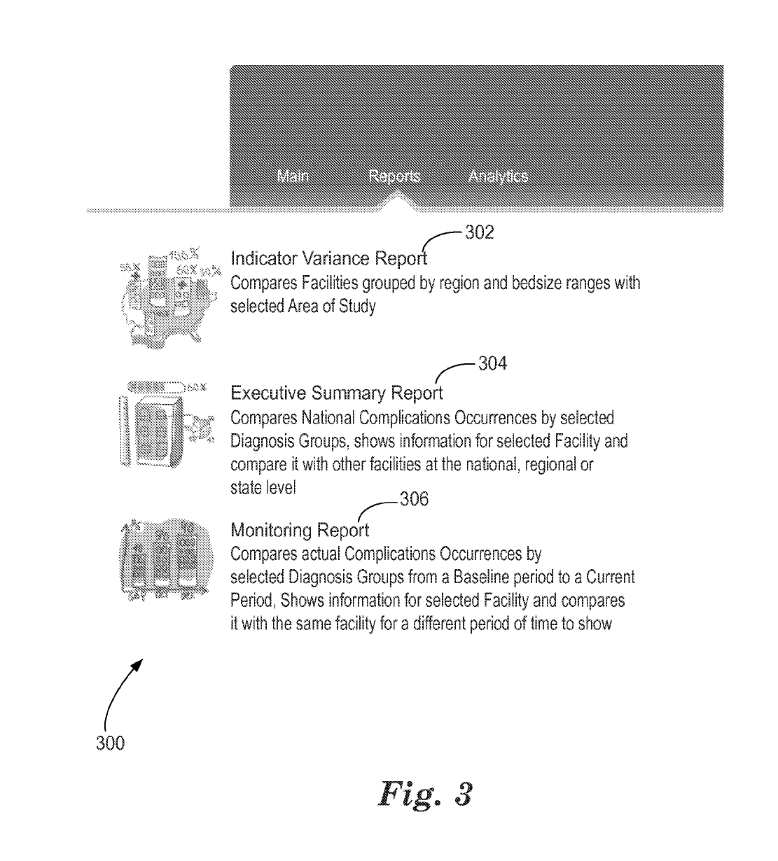

FIG. 3 is another exemplary computer screen shot of a web page that may be delivered from server computer 110 to client computer 150 for presentation to a user of computerized system 100 via display screen 170 of client computer 150. Web page 300 may be presented via a web browser and illustrates the “reports” section of an exemplary system. A number of different reports may be supported, including an indicator variance report 302 that e.g., allows users to compare facilities grouped by region and bedsize ranges with selectable parameters. Web page 300 may also support executive summary reports 304 that, for example, allow users to compare occurrences of conditions in a given facility to national averages, allow users to see information on facilities, and allow users to compare facilities to other facilities nationally, regionally or at a state level. Web page 300 may also support monitoring reports 306 that, e.g., allow users to compare actual occurrences of conditions at a facility for different diagnostic areas.

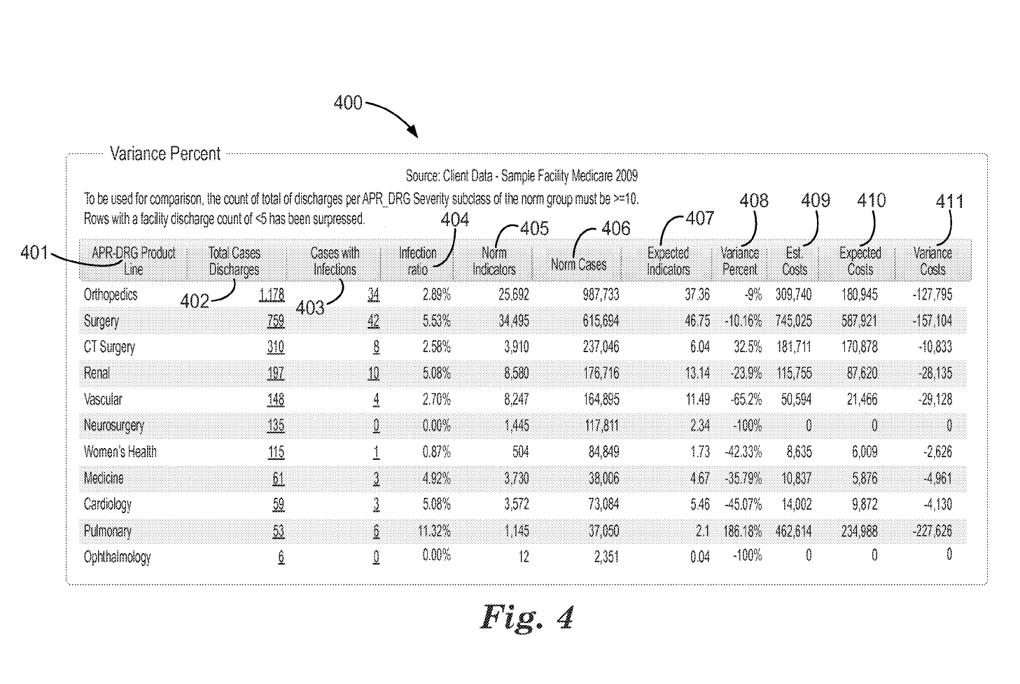

FIG. 4 is an exemplary computer screen shot of a web page 400 illustrating specific types of processed medical data consistent with the techniques described in this disclosure. As with the web pages of FIGS. 2 and 3, the specific data in web page 400 of FIG. 4 may be generated by server computer 110 and stored as part of processed medical data 120 (such as in a database (not shown) or memory 114). The processed data may be communicated from server computer 110 to client computer 150 via communication interfaces 126, 152 and network 140. A user may identify the URL for web page 400 or simply select a link to that URL via a graphical user interface (GUI). Web page 400 may present processed medical data 176, and may be rendered via a web browser executing on processor 160 of client computer 150.

Web page 400 illustrates data relevant to a specific type of medical facility-acquired condition, in this case, surgical site infections in a given year. Similar web pages and data could be generated for a wide variety of other types of medical facility-acquired conditions for other defined periods of time (e.g., other years, months, or multiple years or months), including but not limited to an infection acquired at the medical facility, an injury that occurred in the medical facility, a complication due to an error at the medical facility, or a complication due to improper medication at the medical facility.

In web page 400, the “APR-DRG Product Line” column 401 represents exemplary service groups, in this example, including orthopedics, surgery, cardiothoracic (CT) surgery, renal, vascular, neurosurgery, woman's health, medicine, cardiology, pulmonary, and ophthalmology. APR-DRG stands for “All Patient Refined Diagnostic Related Groups.” The service groups shown in web page 400 are merely exemplary, and other types of service groups could also be defined or used consistent with this disclosure. In general, a service group refers to one or more conditions or procedures that are grouped together, such as by medical practice, a particular group of diagnostic procedures, a particular group of conditions, or other groupings. In other examples, other diagnostic related groups (DRGs) could be defined, such as for example, Medicare DRG (CMS-DRG & MS-DRG); Refined DRGs (R-DRG); All Patient DRGs (AP-DRG); Severity DRGs (S-DRG); All Patient, Severity-Adjusted DRGs (APS-DRG); All Patient Refined DRGs (APR-DRG); International-Refined DRGs (IR-DRG), and so forth.

In web page 400, the “Total Cases Discharged” column 402 represents numbers of cases. Each of these numbers of cases listed in column 402 is associated with in-patient medical procedures of a particular service group at the medical facility. The service group may also be referred to as a “service line group.” The data may be obtained via data mining of medical data 118, which may comprise MEDPAR data coded with ICD codes in the example of FIG. 4. Using these ICD codes (ICD-9, ICD-10 or future extensions of ICD codes), one of modules 130 may determine the number of cases associated with in-patient medical procedures of a particular service group at the medical facility. The numbers of cases are shown in web page 400 for a plurality of different service groups defined in the “APR-DRG Product Line” column 401. Each number listed in column 402 may comprise a web link that links to a list of the actual cases and data (for example, clinical and financial data) associated with such cases. Additional data links from medical facilities clinical data repository may be accessed to provide data from infection surveillance systems, laboratory results, medications administered, patient surveys to provide more information about the patients, treatment of the facility acquired conditions, or other data.

In web page 400, the column “Cases with Infections” 403 represent subsets of the numbers of cases for the in-patient medical procedures of the particular service group at the medical facility, where the subset is associated with one or more medical facility-acquired conditions. In this example, the medical facility-acquired condition is an infection, such as a surgical site infection, acquired at the medical facility while under the care of the medical facility. The numbers representing the subsets in column 403 may comprise a web link that links to a list of the actual cases and data associated with such cases.

According to one aspect of this disclosure, the data in column 409 may be generated to provide the user with an indication of costs associated with those cases that have medical facility-acquired conditions, i.e., medical facility-acquired infections in the example of FIG. 4. In web page 400, the column “Est. Costs” 409 represents estimated costs associated with the subsets listed in column 403. According to this disclosure, generating the estimated costs may be performed by one of modules 130 of server computer 110. For example, a first one of modules 130 may determine a first subset of cases associated with in-patient medical procedures of a particular service group at the medical facility (i.e., one of the numbers listed in column 402), and a second one of modules 130 may determine a second subset of the first subset of cases for the in-patient medical procedures of the particular service group at the medical facility, where the second subset is associated with one or more medical facility-acquired conditions and shown e.g., as one of the numbers in column 403. A third one of modules 130 may then generate estimated costs associated with the second subset of the first subset of cases (shown as one of the numbers in column 409).

Determining the first subset of cases and determining the second subset of the first subset of cases may include analyzing diagnostic codes associated with a set of government-acquired medical data (e.g., ICD codes of MEDPAR data within medical data 118). Furthermore, as described in greater detail below, generating the estimated costs may include determining actual charges submitted to a government by the medical facility for the second subset of the first subset of cases, determining a cost-to-charge metric associated with the medical facility, and calculating the estimated costs based on the actual charges and the cost-to-charge metric. In particular, the actual charges submitted to the government may be included in the ICD-coded MEDPAR data within medical data 118. In addition, the MEDPAR data may include cost metrics, such as cost-to-charge ratios, defined for each medical facility that sends such data to Medicare, which is included in the MEDPAR repository. One of modules 130 may apply the cost metric to the actual charges associated with the subset of cases that have medical facility-acquired conditions (say infections) for that facility. For example, the actual charges may be multiplied by a cost-to-charge metric, and the result of this multiplication may be listed as an estimated cost (e.g., one of the numbers in column 409) on web page 400. The estimated costs are highly useful to medical facilities or medical consultants as they can indicate estimations of the out-of-pocket costs incurred by the medical facility for cases that have medical facility-acquired conditions.

Another very useful set of estimations are listed in the “Expected Costs” column 410. These numbers may be generated by one of modules 130 as the expected costs of the subset of the number of cases (e.g., listed in column 403), but in the absence of the medical facility-acquired conditions. In other words, the expected costs shown in column 410 lists an estimation of what costs would have been if the medical facility-acquired condition (e.g., infection) had not occur in the given cases. These are also very useful numbers for the medical facility or for consultants, particularly as a comparison to the estimated costs shown in column 409, which include the costs of treating the medical facility-acquired conditions (e.g., the infections). Using these numbers, medical facilities or medical consultants may be able to identify areas of practice or specific procedures that have high out-of-pocket costs, some or all of which may not be recoverable from Medicare due to the medical facility-acquired nature of the conditions. The cost metric may comprise a cost-to-charge metric or another metric indicative of the costs relative to charges for that facility.

The expected costs of the second subset of the first subset of cases in the absence of the medical facility-acquired conditions (e.g., the expected costs listed in column 410) may comprise actual charges that would have been submitted to the government by the medical facility for the second subset of cases in the absence of the medical facility-acquired conditions, multiplied by the cost metric for that medical facility. Alternatively, the expected costs may comprise actual charges submitted to the government by the medical facility for a third subset of cases selected from the first subset of cases, wherein the cases in third subset of cases are comparable to the cases in the second subset of cases, except that they are not associated with the medical facility-acquired condition.

The “Variance Cost” column 411 generally represents the difference between estimated costs (column 409) and expected costs (column 410). In other words, column 411 lists the variances of the estimated costs of cases with a medical facility-acquired condition relative to the expected costs (e.g., estimated costs of the same types of cases in the absence of the medical facility-acquired condition). In the case where MEDPAR data is used, these numbers may be estimations of the cost of out of pocket expenses that are likely unrecoverable from Medicare. Accordingly, the medical facility or a consultant may use these numbers to quantify the non-reimbursable expenses resulting from medical facility-acquired conditions.

The “Infection Ratio” column 404 generally represents ratios (in this case listed as percentages) of the subset of cases with medical facility-acquired conditions (column 403) to the total number of cases (column 402). These infection ratios in column 404 can be useful to show the extent of cases that have medical facility-acquired conditions for each given service group.

The “Norm Indicators” column 405 may represent the normative number of cases with medical facility-acquired conditions. The “Norm Cases” column 406 may represent a total normative number of cases with medical facility-acquired conditions. The normative collection may be defined based on a collection of medical facilities in a nation, a collection of medical facilities in a state, a collection of medical facilities in a nation-state, a collection of medical facilities in a particular geographically defined location, or any other generally large sample of facilities so as to provide a level of comparison of data for a given facility to some norm. The user may be able to select the normative level of comparison so as to define column 405 by state, region, nation, or the like.

One of modules 130 may determine a second number of cases associated with the in-patient medical procedures of the particular service group at a normative collection of medical facilities based on a set of government-acquired medical data (e.g., one of the numbers in column 406 for a given service group). Also, one of modules 130 may determine a second subset of the second number of cases associated with the in-patient medical procedures of the particular service group at the normative collection of medical facilities, wherein the second subset is associated with the one or more medical facility-acquired conditions (e.g., one of the numbers in column 405 for the given service group). One of modules 130 may then generate an expected number of cases (e.g., one of the numbers in column 407 for the given service group) based on the first number of cases (e.g., one of the numbers in column 402 for the given service group), the second number of cases (e.g., one of the numbers in column 406 for the given service group) and the second subset (e.g., one of the numbers in column 405 for the given service group). In this case, the expected number indicates the expected number for the first subset. In other words, the expected number indicates how many cases with the medical facility-acquired conditions should be expected for a facility based on a national, state or regional norm.

Again, determining the first number of cases (e.g., one of the numbers in column 402 for the given service group), determining the first subset of the first number of cases (e.g., one of the numbers in column 403 for the given service group), determining the second number of cases (e.g., one of the numbers in column 406 for the given service group) and determining the second subset of the second number of cases (e.g., one of the numbers in column 405 for the given service group) may each comprise analyzing diagnostic codes associated with a set of government-acquired medical data or other types of medical data describe herein. The set of medical data may be included in medical data 118 and data mined so as to generate such processed medical data 120. In some examples, the set of medical data may comprise data in the MEDPAR repository, and the diagnostic codes may comprise ICD codes in the MEDPAR repository. The cost metric, discussed above, may also be defined by data in the MEDPAR repository, e.g., a cost-to-charge ratio maintained for a medical facility that sends invoices to Medicare. Alternatively, a medical facility may supply its own calculation of the cost metric, such as a facility-defined cost-to-charge ratio.

Although examples are given herein related to government-acquired medical data may comprise data in the MEDPAR repository, the techniques of this disclosure may apply to other types of medical data, including but not limited to government-acquired medical data from a medical information repository, medical data submitted to a government by the medical facility, medical data submitted to the government by many medical facilities, medical data received from one or more medical facilities, medical data received from one or more insurance companies, and medical data associated with all-payer health insurance claims.

The “Variance Percent” column 408 may represent the variance between the subset of the number of cases at a given facility that have medical facility-acquired conditions (e.g. one of the numbers in column 403) relative to the expected number of cases based on the norms (e.g., one of the numbers in column 407). Although variances are shown as percentages in column 408, the actual difference between actual cases with medical-facility acquired conditions (i.e., the subset) and the expected number of cases based on the norms could also be defined.

FIG. 5 is a flow diagram consistent with a technique that may be performed by server computer 110 within computerized system 100. A first module executing in processor 112 (e.g., one of modules 130) determines a first subset of cases associated with a first parameter, e.g., in-patient medical procedures of a particular service group at the medical facility (step 501). A second module executing in processor 112 (e.g., one of modules 130) determines a second subset of the first subset of cases, wherein the second subset is associated with one or more medical facility-acquired conditions (step 502). A third module executing in processor 112 (e.g., one of modules 130) generates estimated costs associated with the second subset of the first subset of cases (step 503). Referring again to FIG. 4, the first subset of cases determined in step 501 of FIG. 5 may correspond to one of numbers in column 402 of FIG. 4. The second subset of the first subset of cases determined in step 502 of FIG. 5 may correspond to one of numbers in column 403 of FIG. 4. The estimated costs generated in step 503 of FIG. 5 may correspond to one the numbers in column 409 of FIG. 4.

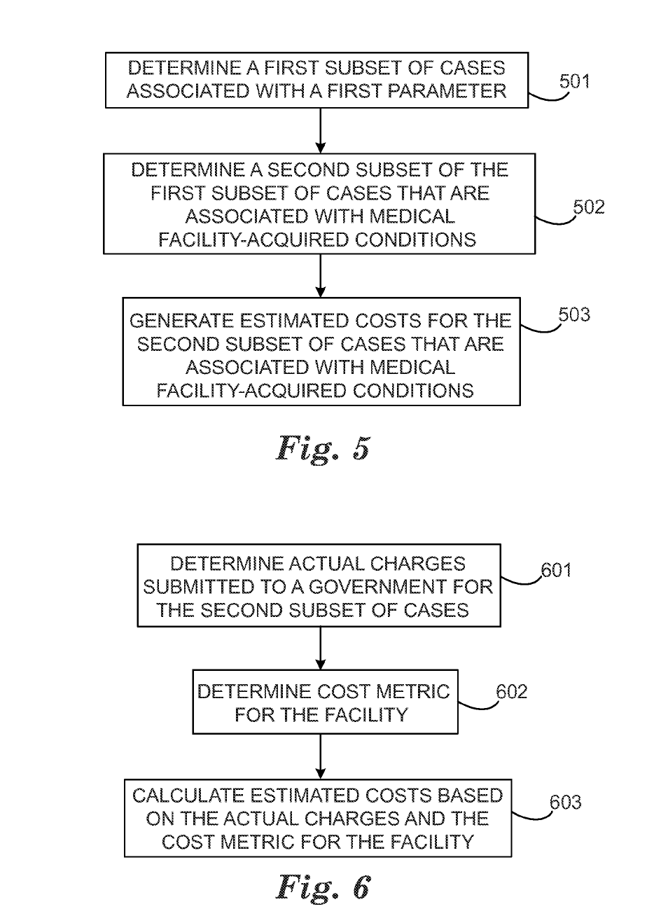

FIG. 6 is a flow diagram illustrating specifically how the third module executing in processor 112 (e.g., one of modules 130) generates estimated costs associated with the second subset of the first subset of cases (e.g., step 503 of FIG. 5). As shown in FIG. 6, the module (e.g. one of modules 130) determines actual charges submitted to a government for the second subset of cases (step 601), e.g., by analyzing government-acquired data from the MEDPAR repository. The module (e.g., one of modules 130) then determines a cost metric, such as a cost-to-charge metric or actual change per case, for the medical facility (step 602), which in some cases, may also be obtained from government-acquired data from the MEDPAR repository. The module (e.g., one of modules 130) calculates the estimated costs based on the actual charges and the cost metric for the medical facility (step 603).

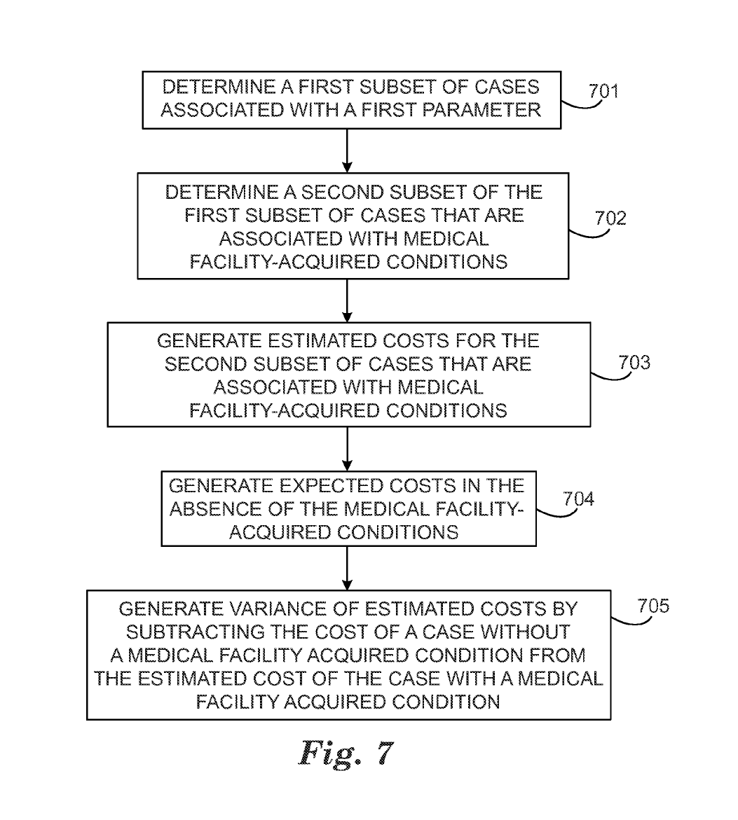

FIG. 7 is another flow diagram consistent with a technique that may be performed by server computer 110 within computerized system 100. A first module executing in processor 112 (e.g., one of modules 130) determines a first subset of cases associated with a first parameter, e.g., in-patient medical procedures of a particular service group at the medical facility (step 701). A second module executing in processor 112 (e.g., one of modules 130) determines a second subset of the first subset of cases for the in-patient medical procedures of the particular service group at the medical facility, wherein the second subset is associated with one or more medical facility-acquired conditions (step 702). A third module executing in processor 112 (e.g., one of modules 130) generates estimated costs associated with the second subset of the first subset of cases (step 703). FIG. 6 sets forth one method for generating estimated costs associated with the second subset of cases in step 703 of FIG. 7. The first susbet of cases determined in step 701 of FIG. 7 may correspond to one of numbers in column 402 of FIG. 4. The second subset of cases determined in step 702 of FIG. 7 may correspond to one of numbers in column 403 of FIG. 4. The estimated costs generated in step 703 of FIG. 7 may comprise estimated costs for the number of cases that are associated with the medical facility-acquired condition and may correspond to one of the numbers in column 409 of FIG. 4.

A fourth module (e.g., one of modules 130) generates expected costs in the absence of the medical-facility acquired conditions (step 704). The expected costs generated in step 704 may correspond to one of the expected costs in column 410 of FIG. 4. A fifth module may then generate a variance of the estimated costs relative to expected costs (step 705), such as by subtracting the cost of one or more cases without a medical facility-acquired condition from the estimated cost of corresponding one or more cases with a medical facility acquired condition. The variance generated in step 705 may correspond to one of the variance costs in column 411 of FIG. 4. The variance may comprise a difference between the estimated costs and the expected costs, or could be represented as a percentage or ratio of the estimated costs relative to the expected costs.

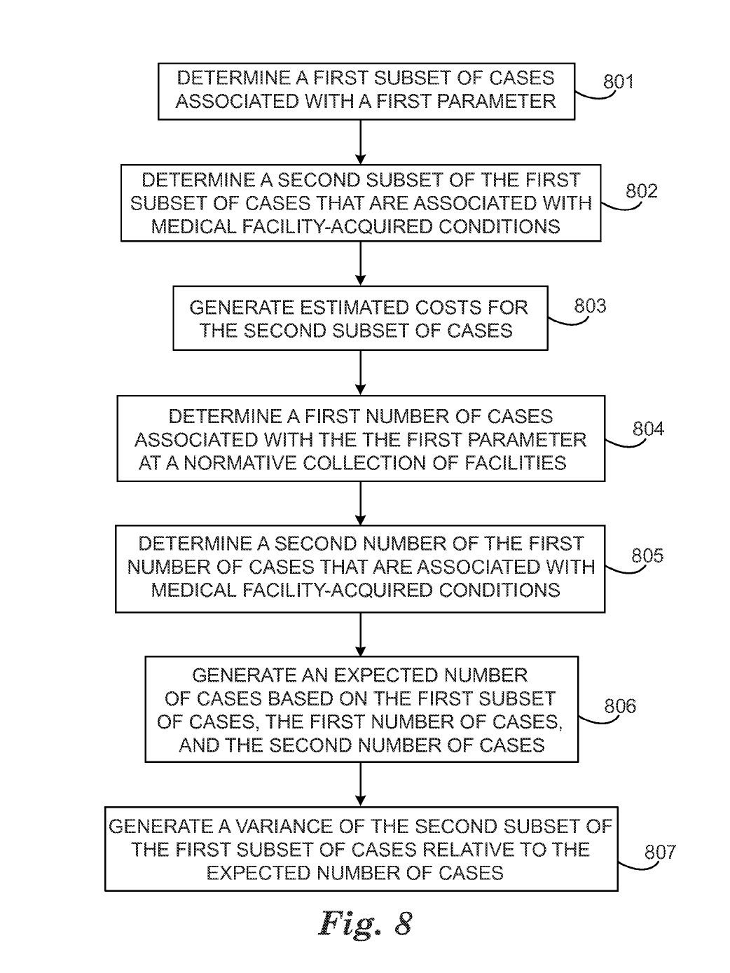

FIG. 8 is another flow diagram consistent with a technique that may be performed by server computer 110 within computerized system 100. A first module executing in processor 112 (e.g., one of modules 130) determines a first subset of cases associated with a first parameter, e.g., in-patient medical procedures of a particular service group at the medical facility (step 801). A second module executing in processor 112 (e.g., one of modules 130) determines a second subset of the first subset of cases for the in-patient medical procedures of the particular service group at the medical facility, wherein the second subset is associated with one or more medical facility-acquired conditions (step 802). A third module executing in processor 112 (e.g., one of modules 130) generates estimated costs associated with the second subset of the first subset of cases (step 803). FIG. 6 sets forth one method for generating estimated costs associated with the second subset of the first subset of cases, such as defined by in step 803 of FIG. 8.

As with steps 501-503 of FIG. 5 and steps 701-703 of FIG. 7, the steps 801-803 of FIG. 8 are reflected in the example of FIG. 4. For example, the first subset of cases determined in step 801 of FIG. 8 may correspond to one of numbers in column 402 of FIG. 4. The second subset of the first subset of cases determined in step 802 of FIG. 8 may correspond to one of numbers in column 403 of FIG. 4. The estimated costs generated in step 803 of FIG. 8 may correspond to one the numbers in column 409 of FIG. 4.

A fourth module executing in processor 112 (e.g., one of modules 130) determines a first number of cases associated with the first parameter at a normative collection of medical facilities based on a set of medical data (step 804). A fifth module executing in processor 112 (e.g., one of modules 130) determines a second number of cases that form a subset of the first number of cases associated with the first parameter at the normative collection of medical facilities, wherein the second number of cases is associated with the one or more medical facility-acquired conditions (step 805). A sixth module executing in processor 112 (e.g., one of modules 130) generates an expected number of cases based on the first subset of cases, the first number of cases and the second number of cases (step 806), wherein the expected number indicates the expected number of cases within the second subset of cases. For example, the first number of cases determined in step 804 of FIG. 8 may correspond to one of numbers in column 406 of FIG. 4. The second number of the first number of cases determined in step 805 of FIG. 8 may correspond to one of numbers in column 405 of FIG. 4. The expected number of cases generated in step 806 of FIG. 8 may correspond to one the numbers in column 407 of FIG. 4. A seventh module executing in processor 112 (e.g., one of modules 130) may also generate a variance of the second subset of the first subset of cases relative to the expected number of cases (step 807). The variance of the second subset of the first subset of cases relative to the expected number of cases may correspond to one of the numbers in column 408 of FIG. 4.

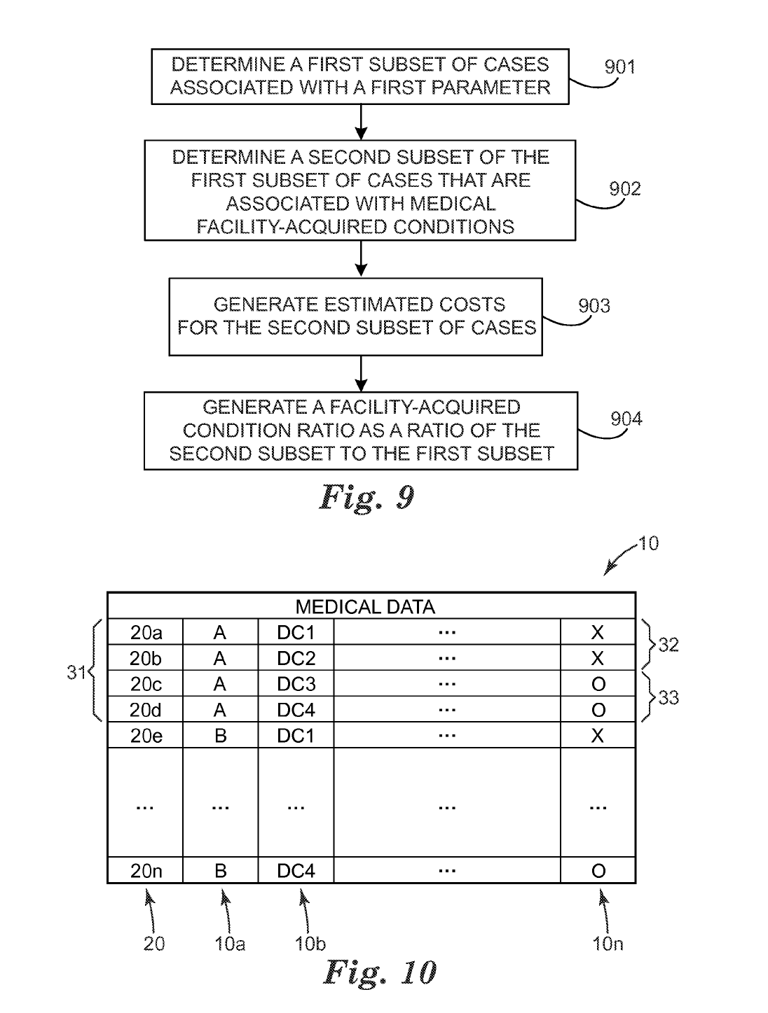

FIG. 9 is another flow diagram consistent with a technique that may be performed by server computer 110 within computerized system 100. A first module executing in processor 112 (e.g., one of modules 130) determines a first subset of cases associated with a first parameter (step 901). A second module executing in processor 112 (e.g., one of modules 130) determines a second subset of the first subset of cases, wherein the second subset is associated with one or more medical facility-acquired conditions (step 902). A third module executing in processor 112 (e.g., one of modules 130) generates estimated costs associated with the second subset of cases (step 903). Again, FIG. 6 sets forth one method for generating estimated costs associated with the second subset of cases, such as defined by in step 903 of FIG. 9.

As with steps 501-503 of FIG. 5, steps 701-703 of FIG. 7, and steps 801-803 of FIG. 8, the steps 901-903 are reflected in the example of FIG. 4. For example, the first subset of cases determined in step 901 of FIG. 9 may correspond to one of numbers in column 402 of FIG. 4. The second subset of cases determined in step 902 of FIG. 9 may correspond to one of numbers in column 403 of FIG. 4. The estimated costs generated in step 903 of FIG. 9 may correspond to one the numbers in column 409 of FIG. 4.

A fourth module executing in processor 112 (e.g., one of modules 130) generates a facility-acquired ratio as a ratio of the second subset of cases relative to the first subset of cases (step 904). The facility-acquired ratio generated in step 904 of FIG. 9 may correspond to one the numbers in column 404 of FIG. 4, which is an infection ratio in the example of FIG. 4.

The techniques of this disclosure can generate useful information for medical facilities or consultants based on publicly available data from the MEDPAR repository, or other medical data. On average, statistics show that cases without surgical site infections cost less to treat. Avoiding or eliminating medical facility-acquired surgical site infections may improve the financial performance of the facility, especially in reimbursement systems designed to reimburse a fixed amount per case regardless of the cost to deliver treatment. The techniques of this disclosure may help to identify and reduce the incidence of medical facility-acquired infections to avoid unnecessary costs, and may also identify areas where steps can be taken to avoid future costs due to infections or other medical facility-acquired conditions.

The techniques may also be used to compare medical facilities to other facilities, or to state, regional or national norms. Once costs are estimated, the medical facility may be motivated to implement procedures, devices, or techniques to reduce such costs. Accordingly, consultants may use the techniques of this disclosure in order to aid marketing of procedures, devices, or techniques to medical facilities, and may use the system and techniques of this disclosure to specifically target medical facilities and practice groups therein that have significant levels of non-reimbursed costs due to medical facilities-acquired conditions.

The techniques of this disclosure may be implemented in a wide variety of computer devices, such as servers, laptop computers, desktop computers, notebook computers, tablet computers, hand-held computers, smart phones, and the like. Any components, modules or units have been described provided to emphasize functional aspects and does not necessarily require realization by different hardware units. The techniques described herein may also be implemented in hardware, software, firmware, or any combination thereof. Any features described as modules, units or components may be implemented together in an integrated logic device or separately as discrete but interoperable logic devices. In some cases, various features may be implemented as an integrated circuit device, such as an integrated circuit chip or chipset.

If implemented in software, the techniques may be realized at least in part by a computer-readable medium comprising instructions that, when executed in a processor, performs one or more of the methods described above. The computer-readable medium may comprise a tangible computer-readable storage medium and may form part of a computer program product, which may include packaging materials. The computer-readable storage medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The computer-readable storage medium may also comprise a non-volatile storage device, such as a hard-disk, magnetic tape, a compact disk (CD), digital versatile disk (DVD), Blu-ray disk, holographic data storage media, or other non-volatile storage device.

The term “processor,” as used herein may refer to any of the foregoing structure or any other structure suitable for implementation of the techniques described herein. In addition, in some aspects, the functionality described herein may be provided within dedicated software modules or hardware modules configured for performing the techniques of this disclosure. Also, the techniques could be fully implemented in one or more circuits or logic elements, which could also be considered a processor.

These and other embodiments are within the scope of the following claims.

1. A computer-implemented method of processing medical data, the method comprising;
selecting a first subset of cases associated with a first parameter from medical data associated with a plurality of cases:
determining a second subset of the first subset of cases associated with at least one medical facility-acquired condition;
determining a third subset of the first subset of cases not associated with the at least one medical facility-acquired condition;
generating estimated costs associated with the second subset of cases, wherein generating the estimated costs comprises
determining actual charges for the second subset of cases,
identifying a cost metric, and
calculating the estimated costs associated with the second subset of cases based on the
actual charges for the second subset of cases and the cost metric;
generating expected costs of the second subset of the first subset of cases in the absence of the at least one medical facility-acquired condition, wherein generating the expected costs comprises
determining actual charges for the third subset of cases, and calculating the expected costs based on the actual charges for the third subset of cases and the cost metric.

2. The method of claim 1, further comprising receiving the first parameter, wherein the first parameter is associated with at least one of a geographic region, a medical facility, a service group, and a patient medical procedure.

3. The method of claim 2, further comprising receiving a second parameter and using the second parameter to determine the at least one medical facility acquired conditions.

4. The method of claim 3, wherein the medical facility-acquired conditions comprise one or more of:
an infection acquired at the medical facility;
an infection resulting from treatment at the medical facility;
an injury that occurred in the medical facility;
a complication due to an error at the medical facility;
a complication due to an error by personnel providing services on behalf of the medical facility; and
a complication due to improper medication at the medical facility.

5. The method of claim 1, wherein determining the second subset of the first subset of cases comprises identifying cases associated with at least one diagnostic code indicative of the at least one medical facility-acquired condition.

6. The method of claim 1, wherein the medical data comprises one or more of
government-acquired medical data from a medical information repository;
medical data submitted to a government by at least one medical facility;
medical data received from one or more medical facilities;
medical data received from one or more insurance companies; and
medical data associated with all-payer health insurance claims.

7. The method of claim 1, wherein determining actual charges comprises determining charges submitted to a reimbursement entity.

8. The method of claim 1, wherein the cost metric comprises a cost-to-charge metric defined by a ratio in a Medicare Provider Analysis and Review (MEDPAR) repository.

9. The method of claim 8, wherein the cost metric is defined by the medical facility.

10. The method of claim 1, wherein the first subset or cases comprises a number of eases and wherein the method further comprises:
determining a first number of cases associated with the first parameter from medical data associated with a normative collection of medical facilities;
determining a second number of cases within the first number of cases, wherein the second number of cases are associated with the one or more medical facility-acquired conditions; and
generating an expected number of cases within the second subset of the first subset of cases based on the first number of cases, the second number of cases, and the number of cases within the first subset of cases.

11. The method of claim 10, wherein determining the second number of cases comprises identifying cases associated with at least one diagnostic code indicative of the at least one medical facility-acquired condition.

12. The method of claim 10, wherein the normative collection of medical facilities are associated with at least one of a same geographic location, a same source of funding, a same source of reimbursement, and a same patient demographic.

13. The method claims 12, further comprising receiving a third parameter and using the third parameter to identify the normative collection of medical facilities.

14. The method of claim 10, further comprising generating a variance of the second subset of the first subset of cases relative to the expected number of cases within the second subset of cases.

15. The method of claim 1, further comprising generating a facility-acquired ratio as a ratio of the second subset of cases to the first subset of cases.

16. The method of claim 1, further comprising generating a variance of the estimated costs relative to the expected costs.

17. The method of claim 1, wherein the method is performed by a server computer, the method further comprising:
sending the medical data to a client computer, wherein the client computer:
displays the first subset of cases;
displays the second subset of cases; and
displays the estimated costs associated with the second subset cases.

18. The method of claim 17, wherein the server computer sends the medical data to the client computer u an internet protocol (IP).

19. A computerized system for processing medical (film, the system comprising a computer that includes:
as first module that selects a first subset of cases associated with the first parameter from medical data associated with a plurality of cases;
a second module that determines a second subset of the first subset of cases associated with at least one medical facility-acquired condition;
a third module that determines a third subset of the first subset of cases not associated with the at least one medical facility-acquired condition;
a fourth module that generates estimated costs associated with the second subset of cases, wherein generating the estimated costs comprises
determining, actual charges for the second subset of cases,
identifying a cost metric, and
calculating the estimated costs associated with the second subset of cases based on the
actual charges for the second subset of cases and the cost metric; and
a fifth module that generates expected costs of the second subset of the first subset of cases in the absence of the at least one medical facility-acquired condition, wherein generating the expected costs comprises
determining actual charges for the third subset of cases, and calculating the expected costs based on the actual charges for the third subset of cases and the cost metric.

20. The system of claim 19, comprising a memory that stores the medical data.

21. A computer-readable storage medium comprising instructions that when executed in a processor cause the processor to process medical data, wherein upon execution the instructions cause the processor to
select a first subset of cases associated with the first parameter from medical data associated with a plurality of cases;
determine a second subset of the first subset of cases associated with at least one medical facility-acquired condition;
determine a third subset of the first subset of cases not associated with the at least one medical facility-acquired condition;
generate estimated costs associated with the second subset of cases, wherein generating the estimated costs comprises
determining actual charges for the second subset of cases,
identifying a cost metric, and
calculating the estimated costs associated with the second subset of cases based on the
actual charges for the second subset of cases and the cost metric;
generate expected costs of the second subset of the first subset of cases in the absence of the at least one medical facility-acquired condition, wherein generating the expected costs comprises
determining actual charges for the third subset of cases, and
calculating the expected costs based on the actual charges for the third subset of cases and the cost metric.
